(19) United States
(12) Patent Application Publication
(10) Pub. No.: US 2026/0192631 A1
(43) Pub. Date: Jul. 9, 2026

(54) Working Machine and Temperature Management System Thereof

(71) Applicant: Caterpillar SARL, Geneva (CH)

(72) Inventors: Kouji KISHIDA, Akashi-shi,Hyogo (JP); Yukari SATO, Akashi-shi,Hyogo (JP); Nobuaki MATOBA, Kako-gun,Hyogo (JP)

(73) Assignee: Caterpillar SARL, Geneva (CH)

(21) Appl. No.: 19/127,852

(22) PCT Filed: Nov. 2, 2023
(86) PCT No.: PCT/EP2023/025457

§ 371 Date: May 7, 2025

(30) Foreign Application Priority Data
Nov. 7, 2022 (JP) 2022-178215

(51) Int. Cl. B60H 1/14; B60H 1/00; B60K 1/00; B60K 11/02; E02F 9/08; E02F 9/16; E02F 9/20; E02F 9/22

(52) U.S. Cl. CPC B60H 1/143; B60H 1/00278; B60K 1/00; B60K 11/02; E02F 9/0866; E02F 9/16; E02F 9/207; E02F 9/2091; B60H 2001/00307; B60K 2001/005; B60K 2001/006; B60K 2001/008; E02F 9/2203; E02F 9/2292

(57) ABSTRACT

Problem: Provide a temperature management system of a working machine that can manage heat by utilizing the heat of hydraulic fluid in a power saving manner while preventing an increase in back pressure, and a working machine including the same. Solution: A temperature management system of a working machine comprises a return line that returns hydraulic oil to a tank a back pressure check valve provided in the return line and providing back pressure to return oil, a diversion line that diverts a portion of the return oil from an upstream side of the back pressure check valve in the return line a coolant line that circulates a coolant used in a heating device that heats an interior of a cab, and a heat exchanger that exchanges heat between the diversion line and the coolant line.

### TECHNICAL FIELD

The present invention relates to a temperature management system of a working machine that utilizes a hydraulic fluid for thermal management and a working machine comprising the same.

### BACKGROUND

Conventionally, in a working machine such as a backhoe, as a heating device that warms the inside of a cab, it is known that obtaining heat from hydraulic oil for operating a hydraulic actuator such as a hydraulic cylinder or a hydraulic motor does not require the supply of energy such as electricity separately (see, for example, Patent Documents 1 and 2).

### PRIOR ART DOCUMENTS

### Patent Documents

Patent Document 1: JP 2021-80706A

Patent Document 2: JP 2022-96243A

### SUMMARY OF THE INVENTION

### Problems to Be Solved by the Invention

However, in the temperature management system of the above-described working machine, a heating device is provided in the return line of the hydraulic oil from the hydraulic actuator to the tank, so when the flow path resistance of the heat exchanger of the heating device is large, the back pressure is high, which may affect the operability of the working device driven by the hydraulic actuator.

In view of this, it is an object of the present invention to provide a temperature management system of a working machine and a working machine comprising the same that can utilize the heat of a hydraulic fluid to save electricity and manage heat while preventing an increase in back pressure.

### Means for Solving the Problem

The invention according to claim 1 is a temperature management system of a working machine comprising a return line for returning a hydraulic fluid to a tank, a back pressure check valve provided in the return line to provide back pressure to a return fluid, a diversion line for diverting a portion of the return fluid from an upstream side of the back pressure check valve in the return line, a coolant line for circulating a coolant used in a heating device for heating an interior of a cab, and a heat exchanger for exchanging heat between the diversion line and the coolant line of the heating device.

The invention according to claim 2, wherein in the temperature management system of the working machine according to claim 1, the temperature management system of the working machine comprises an auxiliary line connected from the tank to the diversion line, a pump provided in the auxiliary line, and an electric motor to operate the pump.

The invention according to claim 3, wherein in the temperature management system of the working machine according to claim 1, the temperature management system of the working machine comprises a coolant line circulating a coolant used in a battery thermal management system regulating a temperature of a battery, and a supply line supplying a part of the coolant of the coolant line of the battery thermal management system to the coolant line of the heating device and provided between the coolant line of the battery thermal management system and the coolant line of the heating device.

The invention according to claim 4, wherein in the temperature management system of the working machine according to claim 1, the temperature management system of the working machine comprises a coolant line that circulates a coolant used in a battery thermal management system to regulate a temperature of a battery, a coolant line that circulates a coolant used in an electrical device thermal management system to regulate a temperature of the electrical device, and a supply line that is provided between the coolant line of the electrical device thermal management system and the coolant line of the battery thermal management system and supplies a part of the coolant of the electrical device thermal management system to the coolant line of the battery thermal management system.

The invention according to claim 5 is a working machine comprising a cab having a heating device, a tank storing a hydraulic fluid, and a temperature management system according to any one of claims 1 to 4.

### Effect of the Invention

According to the invention of claim 1, the heat of the hydraulic fluid can be effectively utilized to heat the interior of the cab in a power-saving manner while preventing an increase in the back pressure due to the flow path resistance of the heat exchanger.

According to the invention according to claim 2, even if the hydraulic fluid is not flowing through the return line, the auxiliary line can be used to send the hydraulic fluid to the heat exchanger, so a heat source that warms the coolant can be obtained.

According to the invention of claim 3, the coolant warmed by recovering the heat of the hydraulic fluid can also be used to warm the battery.

According to the invention according to claim 4, the battery can be warmed with the heat of the electrical device thermal management system, or the electrical device can be cooled with the cold coolant of the battery thermal management system.

According to the invention of claim 5, the interior of the cab can be heated and the power consumption of the temperature management system can be reduced.

### BRIEF DESCRIPTION OF THE DRAWINGS

FIG. 1 is an illustrative diagram illustrating an embodiment of a working machine comprising a temperature management system according to the present invention.

FIG. 2 is an illustrative diagram illustrating a spring or autumn operational action of the same temperature management system.

FIG. 3 is an illustrative diagram illustrating a winter operational action of the same temperature management system.

FIG. 4 is an illustrative diagram illustrating a summer operational action of the same temperature management system.

### DETAILED DESCRIPTION

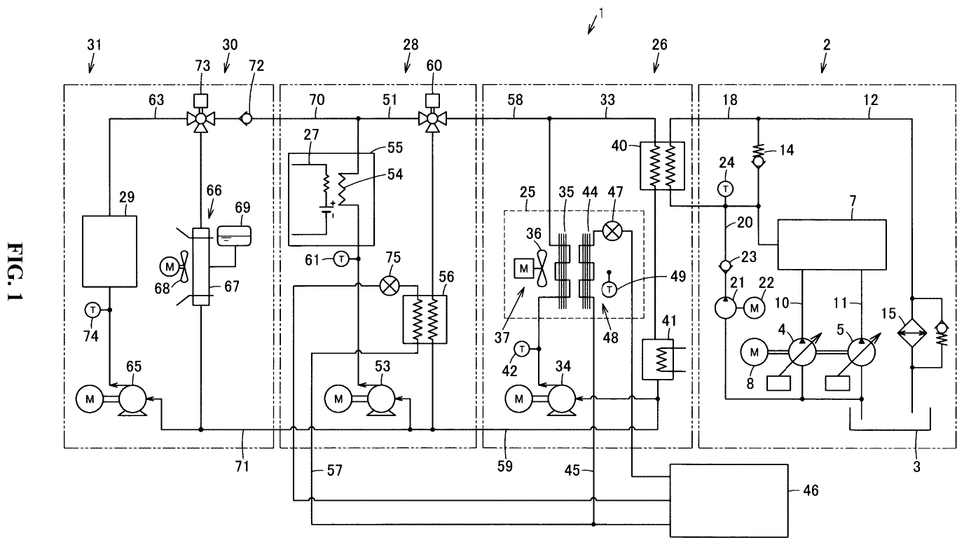

Hereinafter, the present invention will be described in detail below with reference to embodiments shown in FIGS. 1 to 4.

The working machine 1 shown in FIG. 1 is a working machine such as, a hydraulic shovel. In particular, in the present embodiment, the working machine 1 describes an electric working machine such as, an electric hydraulic shovel.

The working machine 1 comprises a fluid pressure circuit 2. In the present embodiment, the fluid pressure circuit 2 is a hydraulic circuit, and comprises a tank 3 for storing hydraulic oil, which is a hydraulic fluid, main pumps 4, 5 for supplying hydraulic oil, a hydraulic cylinder or hydraulic motor constituting a fluid pressure actuator, a control valve 7 for controlling the supply and discharge of hydraulic oil from the main pumps 4, 5 to the hydraulic cylinder or the hydraulic motor, and the like. The control valve 7 is configured to control the flow direction and flow rate of the hydraulic oil to the hydraulic cylinder or the hydraulic motor by switching the position of the spool according to the operation of the operator and communicating or blocking the oil path according to the switching position.

The main pumps 4, 5 are driven by a motor 8 to discharge the hydraulic oil sucked from the tank 3 into the pump lines 10, 11 as high-pressure pressurized oil. In the present embodiment, the motor 8 is an electric motor. The pressure oil discharged into the pump lines 10, 11 is then supplied to the cylinder or motor via the control valve 7 or the like. The return fluid from the cylinder or motor, i.e., the return oil, is also discharged to the tank 3 via the control valve 7, and the return line 12, etc.

The return line 12 is provided with a back pressure check valve 14 that applies back pressure to the return oil. In addition, an oil cooler 15 is provided on a downstream side of the back pressure check valve 14 in the return line 12. The return oil is discharged to the tank 3 via this oil cooler 15.

Furthermore, a diversion line 18 is connected to the return line 12. The diversion line 18 diverts a portion of the return oil from an upstream side of the back pressure check valve 14. The diversion line 18 is connected at both ends to the return line 12, for example, bypassing the back pressure check valve 14.

In addition, an auxiliary line 20 is connected to the tank 3 from the diversion line 18. The auxiliary line 20 is branched from the pump lines 10, 11. The auxiliary line 20 is provided with a pump 21 that sends the hydraulic oil from the tank 3 to the diversion line 18. The pump 21 is operated by an electric motor 22. In addition, a check valve 23 is provided between the downstream side of the pump 21 and the diversion line 18 to prevent a backflow of the hydraulic oil. The diversion line 18 is also provided with a temperature sensor 24 that detects the temperature of the hydraulic oil. In the present embodiment, the temperature sensor 24 is provided at a connection point between the auxiliary line 20 and the diversion line 18, that is, a downmost part of the auxiliary line 20.

The working machine 1 also comprises an air conditioning system 26 that regulates a temperature inside the cab (driver's cabin) 25. In the present embodiment, the working machine 1 further comprises a battery thermal management system 28 that regulates a temperature of the battery 27 forming a power source of the working machine 1. The working machine 1 further comprises an electrical device thermal management system 30 that regulates a temperature of an electrical device 29, such as a motor or an inverter powered by the battery 27. These air conditioning system 26, battery thermal management system 28, and electrical thermal management system 30 configure a temperature management system 31.

The air conditioning system 26 is also referred to as HVAC (Heating Ventilation and Air-Conditioning). The air conditioning system 26 has an endless coolant line 33 that circulates the coolant for temperature regulation. The coolant line 33 is provided with a coolant pump 34 that sends the coolant to the coolant line 33. In the present embodiment, the coolant pump 34 is an electric pump driven by an electric motor.

In addition, the coolant line 33 is provided with a heater core 35 that is configured to include fins in the line through which the coolant sent by the coolant pump 34 passes. Opposite the heater core 35, a fan 36 is provided to send an air-conditioning wind into the room of the cab 25. In the present embodiment, the fan 36 is an electric fan. The heater core 35 and the fan 36 configure a heating device 37 that heats an interior of the cab 25.

Also, a portion of the coolant line 33 is disposed proximate to a portion of the diversion line 18 such that a heat exchanger 40 is configured by a portion of the coolant line 33 and a portion of the diversion line 18. In this heat exchanger 40, a part of the diversion line 18 is on a primary side (high temperature side) and a part of the coolant line 33 is on a secondary side (low temperature side), and is heat exchangeable between a part of the diversion line 18 and a part of the coolant line 33. That is, the heat exchanger 40 is an exhaust heat recovery means that recoveries exhaust heat of the hydraulic oil into the air conditioning system 26.

Furthermore, the coolant line 33 is provided with a heater 41 capable of warming the coolant circulating through the coolant line 33. In the present embodiment, the heater 41 is an electric heater. In the illustrated example, the heater 41 is provided on the downstream side of the heat exchanger 40 at the coolant line 33.

The coolant line 33 is also provided with a temperature sensor 42 that detects the temperature of the coolant. In the present embodiment, the temperature sensor 42 is provided on the coolant line 33 between the coolant pump 34 and the heater core 35. That is, the temperature sensor 42 is provided at an entrance of the coolant to the heater core 35 (heating device 37).

Also, an evaporator 44 for cooling is disposed in proximity to the heater core 35. The evaporator 44 is provided in a first refrigerant circulation line 45, which is a refrigerant circulation line that circulates a refrigerant for cooling. The first refrigerant circulation line 45 is connected to a refrigerant device 46 having a compressor to compress the refrigerant, a condenser to cool the compressed refrigerant, and a receiver to remove impurities and the like from the refrigerant through the condenser. In the present embodiment, the refrigerant device 46 is controlled by a signal from a controller not shown. Also, in the first refrigerant circulation line 45, an expansion valve 47 is provided at an upstream side of the evaporator 44 to regulate the pressure and flow rate of the coolant supplied to the evaporator 44. The evaporator 44, the first refrigerant circulation line 45, the refrigerant device 46, the expansion valve 47, and the fan 36 configure a refrigeration device 48 that cools the interior of the cab 25.

Also, the temperature in the interior of the cab 25, or room temperature, is detected by the temperature sensor 49. Then, in accordance with the temperature information detected by the temperature sensor 42, the set temperature information of the interior of the cab 25 set by the operator and the like, the outside air temperature information not shown, the temperature information detected by a temperature sensor 49, etc., the controller not shown in at least any of the coolant pump 34, the fan 36, and the heater 41 is configured to output a signal to control these.

The battery thermal management system 28 also utilizes a portion of the coolant to control the temperature of this coolant to keep the battery 27 at an optimal temperature.

The battery thermal management system 28 has a coolant line 51 that circulates the coolant. The coolant line 51 is provided with a coolant pump 53 that sends the coolant to the coolant line 51. In the present embodiment, the coolant pump 53 is an electric pump driven by an electric motor. In addition, a part of the coolant line 51 is a heat exchange line 54 through which the coolant, which is sent from the coolant pump 53 disposed in proximity to the battery 27 for heat exchange, passes. A battery unit 55 is configured by the heat exchange line 54 and the battery 27.

The coolant passing through the coolant line 51 is cooled by a cooling device composed of an expansion valve 75 and a chiller 56. In this embodiment, the chiller 56 is cooled via the expansion valve 75 utilizing a portion of the refrigerant sent from the refrigerant device 46. The chiller 56 is configured with a second refrigerant circulation line 57, which is a refrigerant circulation line connected to the refrigerant device 46 in parallel with the first refrigerant circulation line 45, disposed in proximate to a portion of the coolant line 51.

The coolant line 51 is then connected to the coolant line 33 via the supply lines 58, 59. The supply line 58 is branched from between the battery unit 55 and the chiller 56 of the coolant line 51, and is connected between the heater core 35 (heating device 37) and the heat exchanger 40 of the coolant line 33. The supply line 59 is also branched from between the chiller 56 and the coolant pump 53 of the coolant line 51, and is connected between the heater 41 and the coolant pump 34 of the coolant line 33. Therefore, the battery thermal management system 28 is configured with a circuit for sending coolant from the coolant line 51 to the heat exchanger 40 of the air conditioning system 26, a circuit for returning coolant directly to the coolant pump 53 via the chiller 56, and a circuit for returning coolant warmed by the heat exchanger 40 of the air conditioning system 26, or the heat exchanger 40 and the heater 41 to the coolant pump 53 of the coolant line 51.

The flow rate of the coolant from the coolant line 51 to the heat exchanger 40 is controlled by the flow control valve 60. The flow control valve 60 is, for example, a three-way valve that controls the flow rate of the coolant that circulates the coolant line 51 and the flow rate of the coolant that is sent from the coolant line 51 to the coolant line 33 (heat exchanger 40). In the present embodiment, the flow control valve 60 is, for example, an electric three-way valve.

Furthermore, the coolant line 51 is provided with a temperature sensor 61 that detects the temperature of the coolant. In the present embodiment, the temperature sensor 61 is provided between the coolant pump 53 and the heat exchange line 54, i.e., at the inlet of the refrigerant to the battery unit 55. For example, the temperature sensor 61 is enabled to indirectly detect the temperature of the battery 27 via the temperature of the coolant.

Then, in accordance with the temperature information detected by the temperature sensor 61 and the like, a controller, for example, not shown in at least any of the coolant pump 53 and the flow control valve 60, is configured to output signals to control these. That is, because the opening degree of the flow control valve 60 is controlled by the controller in accordance with the temperature information detected by the temperature sensor 61, the flow rate of the coolant that is sent from the coolant line 51 to the coolant line 33 via the supply line 58, and is warmed by the heat exchanger 40 of the coolant line 33, or the heat exchanger 40 and the heater 41 and returned to the coolant line 51 via the supply line 59, is controlled, and thus the temperature of the coolant that circulates the coolant line 51 of the battery thermal management system 28 is controlled in accordance with the opening degree of the flow control valve 60.

The electrical device thermal management system 30 also utilizes a portion of the coolant to control the temperature of this coolant to keep the electrical device 29 at an optimal temperature.

The electrical thermal management system 30 has a coolant line 63 that circulates the coolant. The coolant line 63 is provided with a coolant pump 65 that sends the coolant to the coolant line 63. In the present embodiment, the coolant pump 65 is an electric pump driven by an electric motor. Also, a portion of the coolant line 63 is a heat exchange line through which the coolant is sent from the coolant pump 65 which is disposed in proximity to the electrical device 29 for heat exchange.

The coolant passing through the coolant line 63 is cooled by a radiator 66, which is a cooling device. The radiator 66 comprises a radiator core 67 provided in the coolant line 63, a fan 68 that sends cooling air to the radiator core 67 to cool the coolant, and a coolant tank 69, which is a reservoir tank that stores the coolant while serving as an escape route for the coolant expanded at the coolant line 63. In the present embodiment, the fan is an electric fan driven by an electric motor.

The coolant line 63 is then connected to the coolant line 51 via the supply lines 70, 71. The supply line 70 is branched from between the electrical device 29 of the coolant line 63 and the radiator 66, and is connected between the battery unit 55 of the coolant line 51 and the flow control valve 60 (chiller 56). The supply line 70 is provided with a check valve 72 that prevents a backflow of the coolant from the coolant line 51 to the coolant line 63. The supply line 71 is also branched from between the radiator 66 of the coolant line 63 and the coolant pump 65, and is connected between the chiller 56 of the coolant line 51 and the coolant pump 53. Accordingly, the electrical device thermal management system 30 is configured with a circuit for sending a coolant from the coolant line 63 to the chiller 56 of the battery thermal management system 28, a circuit for returning the coolant directly to the coolant pump 65 via the radiator 66, and a circuit for returning the coolant cooled by the chiller 56 of the battery thermal management system 28 to the coolant pump 65 of the coolant line 63.

The flow rate of the coolant sent from the coolant line 63 to the chiller 56 is controlled by the flow control valve 73. The flow control valve 73 is, for example, a three-way valve, and controls the flow rate of the coolant that circulates the coolant line 63 and the flow rate of the coolant that is sent from the coolant line 63 to the coolant line 51 (chiller 56). Accordingly, the flow control valves 73, 60 enable the electrical device thermal management system 30, the battery thermal management system 28, and the air conditioning system 26 to send coolant to each other. In the present embodiment, the flow control valve 73 is, for example, an electric three-way valve.

Furthermore, the coolant line 63 is provided with a temperature sensor 74 that detects the temperature of the coolant. In the present embodiment, the temperature sensor 74 is provided between the coolant pump 65 and the heat exchange line, i.e., at the inlet of the refrigerant to the electrical device 29. For example, the temperature sensor 74 is enabled to indirectly detect the temperature of the electrical device 29 via the temperature of the coolant.

Then, in accordance with the temperature information detected by the temperature sensor 74 and the like, a controller not shown in at least any of the following: a coolant pump 65, a flow control valve 73, and a fan 68 of the radiator 66, is configured to output signals to control these. That is, the degree of opening of the flow control valve 73 is controlled by the controller in accordance with the temperature information detected by the temperature sensor 74, thereby controlling the flow rate of the coolant that is sent from the coolant line 63 to the coolant line 51 via the supply line 70 and is warmed by the exhaust heat of the battery 27 or cooled by the chiller 56 at the battery unit 55 and returned to the coolant line 63 via the supply line 71. Also, the opening degree of the flow control valve 60 of the battery thermal management system 28 is controlled by the controller in accordance with the temperature information detected by the temperature sensor 74, so that the flow rate of the coolant is controlled, which is sent from the coolant line 63 via the supply line 70, through the coolant line 51, via the supply line 58, to the air conditioning system 26, warmed by the heat exchanger 40 or the heat exchanger 40 and the heater 41, and returned from the coolant line 51 via the supply line 59, via the supply line 71 to the coolant line 63. Accordingly, depending on the degree of opening of the flow control valves 73, 60, the temperature of the coolant that circulates through the coolant line 63 of the electrical device thermal management system 30 is controlled.

Next, operations of the illustrated embodiment will be described.

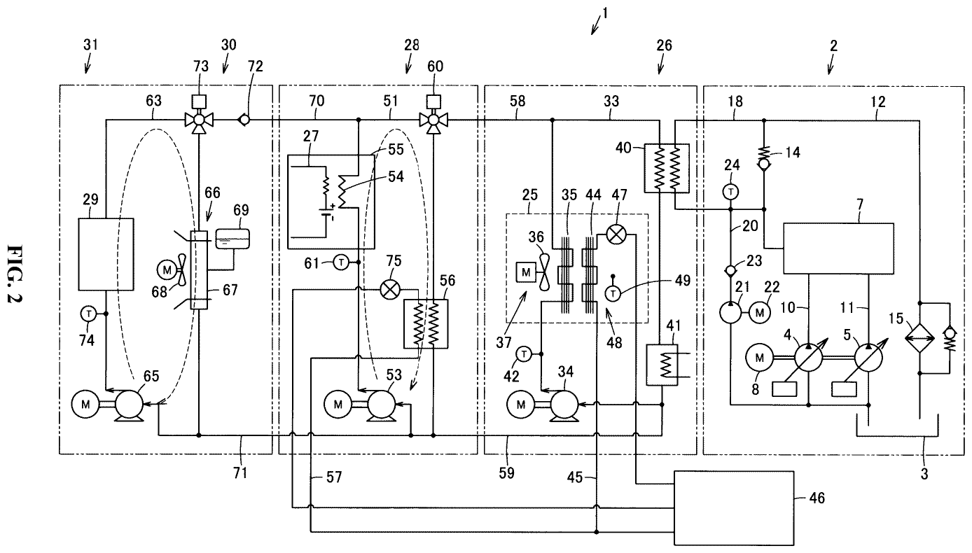

In the temperature management system 31, for example in spring or autumn, as shown in FIG. 2, the battery thermal management system 28 and the electrical device thermal management system 30 individually circulates the coolant, and adjusts the temperature of the battery 27 and the electrical device 29. In the air conditioning system 26, as necessary, the controller may output signals to the coolant pump 34, the fan 36, the heater 41, the refrigerant device 46 to use or stop the heating device 37 or the refrigeration device 48.

In the battery thermal management system 28, if the temperature of the battery 27 is determined to be higher than a predetermined temperature by the temperature information detected by the temperature sensor 61, the controller outputs a signal to the flow control valve 60 to close the flow control valve 60, outputs a signal to the coolant pump 53 and the refrigerant device 46 to drive them, respectively, and supplies a refrigerant to the chiller 56 via the second refrigerant circulation line 57 to cool the coolant circulating the coolant line 51 by the chiller 56, thereby heat exchanging the heat exchange line 54 and the battery 27 at the position of the heat exchange line 54 to keep the battery 27 at an optimal temperature.

In the electrical device thermal management system 30, if the temperature information detected by the temperature sensor 74 determines that the temperature of the electrical device 29 has increased above a predetermined temperature, the controller outputs a signal to the flow control valve 73 to close the flow control valve 73 and outputs a signal to the coolant pump 65 and the fan 68 of the radiator 66 to drive these and cool the coolant circulating through the coolant line 63 by passing through the radiator core 67 fed by the fan 68 to heat exchange the heat exchange line and the electrical device 29 at the location of the heat exchange line to keep the electrical device 29 at an appropriate temperature. That is, when the air conditioning system 26 is not utilized, the external air temperature, i.e., the ambient temperature of the radiator 66, is not high, so the cooling of the electrical device 29 can be adequately covered by the cooling of the coolant by the radiator 66.

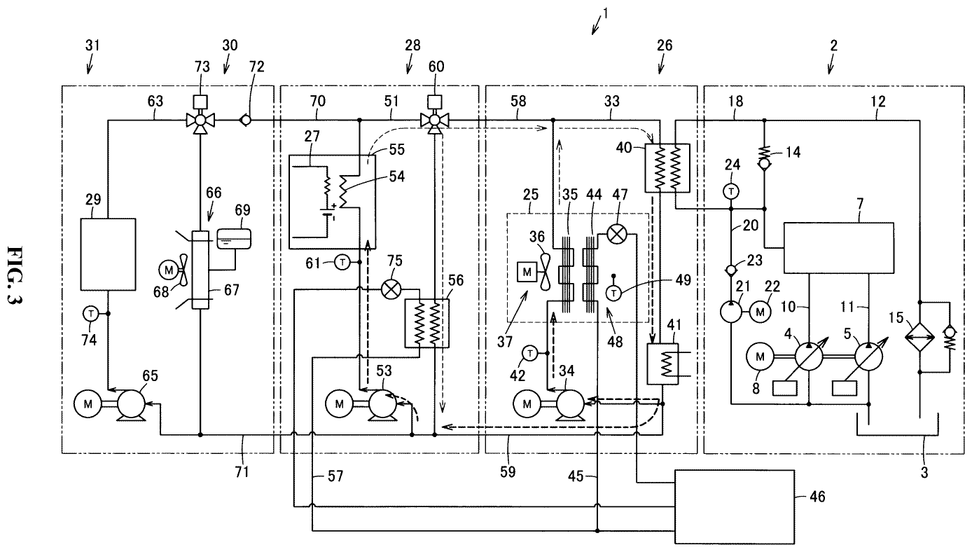

In addition, for example in a period of low external temperature such as winter, as shown in FIG. 3, the temperature management system 31 mainly uses the heating device 37 of the air conditioning system 26 to warm the battery 27 using the heat exchanger 40 of the air conditioning system 26 or the heat exchanger 40 and the heater 41 as necessary, and the electrical device heat management system 30 separately circulates the coolant to adjust the temperature of the electrical device 29, and utilizes the heat of the electrical device thermal management system 30 to the battery thermal management system 28 as necessary.

In the air conditioning system 26, the controller outputs a signal to the coolant pump 34 to drive the coolant pump 34, and utilizes the heat exchanger 40 to recover exhaust heat of the high-temperature hydraulic oil to increase the temperature of the coolant. In addition, for example, when the temperature of the hydraulic oil detected by the temperature sensor 24 is low, if the heating by the exhaust heat of the hydraulic oil is not sufficient, the controller increases the temperature of the coolant by outputting a signal to the heater 41 and driving the heater 41. The controller then drives the fan 36 by a signal to feed the air warmed by the coolant at the heat core 35, i.e., warmed-air, into the interior of the cab 25. The controller monitors the temperature inside the cab 25 with the temperature information detected by the temperature sensor 49, and monitors the temperature of the coolant with the temperature information detected by the temperature sensor 42, while controlling the coolant pump 34, the heater 41, and the fan 36 to maintain the temperature inside the cab 25 at a predetermined set temperature.

Also, in the battery thermal management system 28, if the temperature of the battery 27 is determined to be lower than a predetermined temperature by the temperature information detected by the temperature sensor 61, the controller outputs a signal to control the opening of the flow control valve 60 in accordance with the temperature information detected by the temperature sensor 61, and outputs a signal to the coolant pump 53 to drive the coolant pump 53 to send the coolant from the coolant line 51 to the coolant line 33 of the air conditioning system 26 via the supply line 58 to recover the heat of the high-temperature hydraulic oil using the heat exchanger 40 or the heat exchanger 40 and the heater 41 together with the coolant circulating the coolant line 33 to increase the temperature of the coolant. The temperature increased coolant is partially supplied to the coolant pump 34 and circulated at the coolant line 33, while the rest of the coolant is diverted by the flow control valve 60 at the coolant line 51 of the battery thermal management system 28 via the supply line 59 and merged with the coolant returned to the coolant pump 53 via the chiller 56, and is sent from the coolant pump 53 to the battery unit 55 at the coolant line 51 to heat exchange with the battery 27 at the position of the heat exchange line 54 to warm the battery 27.

In the heat exchanger 40, when the main pumps 4 and 5 in the fluid pressure circuit 2 are operating, such as when the work is on, a part of the return oil from the control valve 7 to the tank 3 is diverted from the upstream side of the back pressure check valve 14 to the diversion line 18 for use. In addition, in the heat exchanger 40, when the working is stopped, if the main pumps 4, 5 in the fluid pressure circuit 2 are not operating, such as when the work is stopped, the controller outputs a signal to the electric motor 22 to drive the electric motor 22, and sends the hydraulic oil from the tank 3 to the diversion line 18 via the pump 21 for use. The oil passing through the diversion line 18 is discharged to the tank 3 via the oil cooler 15.

In the electrical device thermal management system 30, if the temperature of the electrical device 29 is determined to be higher than a predetermined temperature by the temperature information detected by the temperature sensor 74, the controller outputs a signal to the flow control valve 73 to close the flow control valve 73 and outputs a signal to the coolant pump 65 and the fan 68 of the radiator 66 to drive these and cool the coolant circulating through the coolant line 63 by passing through the radiator core 67 fed by the fan 68, so as to heat exchange the heat exchange line and the electrical device 29 at the location of the heat exchange line to keep the electrical device 29 at an appropriate temperature. By controlling the degree of opening of the flow control valves 60, 73, it is also possible to utilize the heat of the electrical device 29 in the battery thermal management system 28.

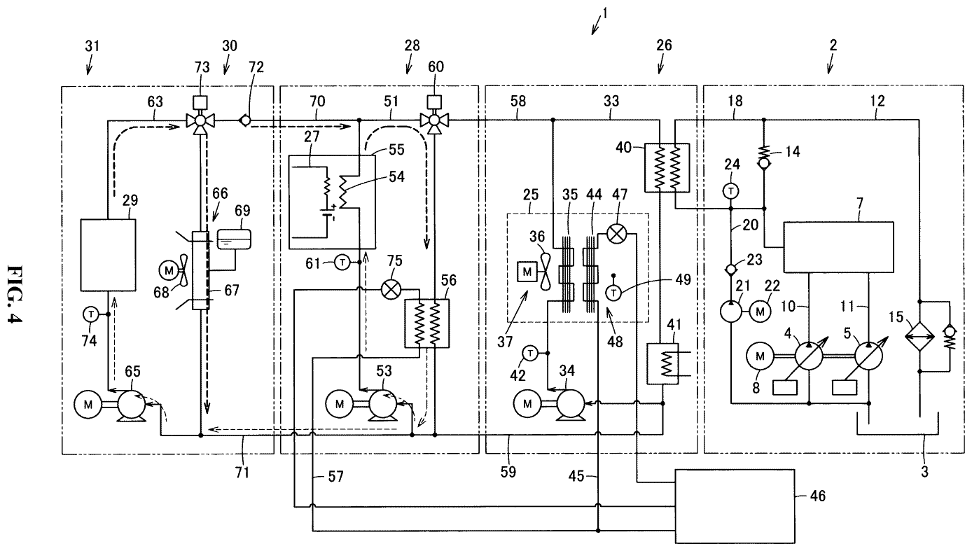

In addition, for example during high temperatures such as in summer, as shown in FIG. 4, the temperature management system 31 mainly uses the refrigeration device 48 of the air conditioning system 26, the battery thermal management system 28 uses a portion of the refrigerant used in the refrigeration device 48 as needed, to cool the battery 27, and the electrical device thermal management system 30 cools the electrical device 29 alone or using the chiller 56 of the battery thermal management system 28.

In the air conditioning system 26, the controller outputs a signal to the coolant pump 34 to stop the coolant pump 34, and outputs a signal to the fan 36 and the refrigerant device 46 to drive these and feed air cooled by the action of the evaporator 44, i.e., cold air, into the interior of the cab 25. The controller monitors the temperature inside the cab 25 with the temperature information detected by the temperature sensor 49, monitoring the temperature of the coolant detected by the temperature sensor 42 at the same time, and controls the fan 36 and the refrigerant device 46 to keep the temperature inside the cab 25 at a predetermined set temperature.

Also, in the battery thermal management system 28, if the temperature of the battery 27 is determined to be higher than a predetermined temperature by the temperature information detected by the temperature sensor 61, the controller outputs a signal to the flow control valve 60 to close the flow control valve 60, and outputs a signal to the coolant pump 53 and the refrigerant device 46 to drive these and use the chiller 56 to lower the temperature of the coolant. A coolant with a reduced temperature is supplied to the coolant pump 53 and sent from the coolant pump 53 to the battery unit 55 via the coolant line 51 to heat exchange with the battery 27 at the position of the heat exchange line 54 to cool the battery 27.

In the electrical device thermal management system 30, if the temperature of the electrical device 29 is determined to be higher than a predetermined temperature by the temperature information detected by the temperature sensor 74, when the electrical device 29 can be cooled by the radiator 66, it operates alone as in spring, autumn, or winter. That is, in the electrical device thermal management system 30, the controller outputs a signal to the flow control valve 73 to close the flow control valve 73 and outputs a signal to the coolant pump 65 and the fan 68 of the radiator 66 to drive these and cool the coolant circulating through the coolant line 63 by passing the radiator core 67 fed by the fan 68, thereby heat exchanging the heat exchange line and the electrical device 29 at the location of the heat exchange line and cooling the electrical device 29 to maintain an appropriate temperature.

In addition, it is assumed that the cooling of the electrical device 29 by the radiator 66 will be insufficient when the ambient temperature, such as extreme heat or work in high temperature areas, is higher than a predetermined temperature. Accordingly, in the electrical device thermal management system 30, the controller outputs a signal to control the opening degree of the flow control valve 73 in accordance with the temperature information detected by the temperature sensor 74, and outputs a signal to the coolant pump 65 to drive the coolant pump 65 to send the coolant from the coolant line 63 of the electrical device thermal management system 30 to the coolant line 51 of the battery thermal management system 28 via the supply line 70, so as to use the chiller 56 with the coolant circulating through the coolant line 51 to reduce the temperature of the coolant by the refrigerant. The coolant with a reduced temperature is partially supplied to the coolant pump 53 and circulated in the coolant line 51, while the remainder is diverted by the flow control valve 73 in the coolant line 63 of the electrical device thermal management system 30 via the supply line 71 and merged with the coolant returning to the coolant pump 65 via the radiator 66, and sent from the coolant pump 65 to the electrical device 29 via the coolant line 63 so as to heat exchange with the electrical device 29 at the location of the heat exchange line to cool the electrical device 29.

As described above, according to the above-described embodiment, by diverting a part of the return oil by the diversion line 18 from the upstream side of the back pressure check valve 14 provided in the return line 12 for returning the hydraulic oil to the tank 3, and configuring the heat exchanger 40 between the diversion line 18 and the coolant line 33 that circulates the coolant of the heating device 37, the heat of the hydraulic oil can be effectively utilized to heat the interior of the cab 25 with power saving at the heating device 37, while preventing an increase in the back pressure due to the flow path resistance of the heat exchanger 40. Therefore, it is possible to provide a working machine 1 that can be heated in a power-saving manner while suppressing the operation of the fluid pressure actuator due to the increase in the back pressure, that is, the influence on the operability of the working device actuated by the fluid pressure actuator.

In particular, in a case of an electric working machine powered by the battery 27, as the frequency of using the heater 41 to heat the coolant of the heating device 37 increases, the power consumption of the battery 27 increases, so the operation time of the heating device 37 is shortened due to the increase in power consumption of the battery 27, in periods when the frequency of use of the heating device 37 is high, especially in winter. Therefore, in the present embodiment, by recovering the heat of the hydraulic oil and using it to warm the coolant of the heating device 37, the frequency of use of the heater 41 for warming the coolant can be reduced, and the operation time can be secured.

By connecting the auxiliary line 20 from the tank 3 to the diversion line 18 and operating the pump 21 provided in this auxiliary line 20 with the electric motor 22, even if the hydraulic oil is not flowing through the return line 12 without the main pumps 4 and 5 being operated, for example, during a work stoppage, the auxiliary line 20 can be used to send the hydraulic oil to the heat exchanger 40, so a heat source that warms the coolant can be obtained.

By providing a heater 41 in the coolant line 33, even in a state where the temperature of the hydraulic oil is low, the coolant can be warmed using the heater 41. Moreover, because the exhaust heat of the hydraulic oil is used in combination by the heat exchanger 40, the frequency of using the heater 41 is low compared to when the heater 41 alone warms the coolant, and the increase in power consumption can be suppressed.

By providing a supply line 58 between the coolant line 51 used in the battery thermal management system 28 to regulate the temperature of the battery 27 and the coolant line 33 of the heating device 37 to supply a portion of the coolant of the coolant line 51 of the battery thermal management system 28 to the coolant line 33 of the heating device 37, the heat of the hydraulic oil can also be recovered and the warmed coolant can be used to warm the battery 27.

Also, by adjusting the opening degree of the flow control valve 60, the coolant line 51 of the battery thermal management system 28 can be connected with the coolant line 33 of the air conditioning system 26 to share the coolant, so for example, heat generated by the battery 27 can be not only dissipated by the chiller 56, but also used as heating of the cab 25 by opening the flow control valve 60.

Furthermore, by providing a supply line 70 between the coolant line 51 that circulates the coolant used in the battery thermal management system 28 and the coolant line 63 that circulates the coolant used in the electrical device thermal management system 30 that regulates the temperature of the electrical device 29, a part of the coolant of the coolant line 63 of the electrical device thermal management system 30 is supplied to the coolant line 51 of the battery thermal management system 28, so that heat can be exchanged between the electrical device thermal management system 30 and the battery thermal management system 28. For example, in winter, the battery 27 can be warmed with the heat of the electrical device thermal management system 30, and in summer, the cold coolant of the battery thermal management system 28 can be used to cool the electrical device 29.

Then, by adjusting the opening degree of the flow control valve 73, 60, the coolant line 63 of the electrical device thermal management system 30 can be connected with the coolant line 33 of the air conditioning system 26 to share the coolant, for example, heat generated by the electrical device 29 can not only be dissipated by the radiator 66, but also can also be used to warm the battery 27 and heat the cab 25 by opening the flow control valve 73 or the flow control valves 73, 60.

That is, according to the present embodiment, by adjusting the opening degree of the flow control valve 60, 73, the coolant can be exchanged among the coolant line 33, the coolant line 51, and the coolant line 63, so that the exhaust heat of the hydraulic oil, the heating by the heater 41, the exhaust heat of the battery 27, and the exhaust heat of the electrical device 29 can be accommodated with each other among the air conditioning system 26, the battery thermal management system 28, and the electrical device thermal management system 30, thereby enabling the heating, the thermal management of the battery 27, and the electrical device 29 to be possible.

The electrical device thermal management system 30 cools the electrical device 29 by the radiator 66, but even when the cooling by the radiator 66 is insufficient or difficult, such as in extreme heat or high-temperature areas, the opening degree of the flow control valve 73 is adjusted to send the coolant to the coolant line 51 of the battery thermal management system 28, and return the coolant cooled by the chiller 56 to the electrical device thermal management system 30, so that the electrical device 29 can be cooled, and the working machine 1 can be operated even in extreme heat or high-temperature areas.

### INDUSTRIAL APPLICABILITY

The present invention has industrial applicability potential for a business operator engaged in manufacturing, selling, or the like of a temperature management system, and a working machine including the same.

1. A temperature management system of a working machine, characterized in comprising:
a return line for returning hydraulic fluid to a tank;
a back pressure check valve provided in the return line to provide back pressure to return fluid; and
a diversion line diverting a portion of the return fluid from an upstream side of the back pressure check valve in the return line;
a coolant line that circulates a coolant used in a heating device that heats an interior of a cab;
a heat exchanger that exchanges heat between the diversion line and a coolant line of the heating device.

2. The temperature management system of the working machine according to claim 1, characterized in comprising:
an auxiliary line connected from the tank to the diversion line;
a pump provided in the auxiliary line; and
an electric motor that operates the pump.

3. The temperature management system of the working machine according to claim 1, characterized in comprising:
a coolant line that circulates a coolant used in a battery thermal management system that regulates a temperature of a battery;
a supply line provided between the coolant line of the battery thermal management system and the coolant line of the heating device to supply a portion of the coolant of the coolant line of the battery thermal management system to the coolant line of the heating device.

4. The temperature management system of the working machine according to claim 1, characterized in comprising:
a coolant line that circulates a coolant used in a battery thermal management system that regulates a temperature of a battery;
a coolant line that circulates a coolant used in an electrical thermal management system that regulates a temperature of an electrical device; and
a supply line provided between the coolant line of the electrical device management system and the coolant line of the battery thermal management system to supply a portion of the coolant of the coolant line of the electrical device thermal management system to the coolant line of the battery thermal management system.

5. The working machine, characterized in comprising:
a cab having a heating device;
a tank for storing hydraulic fluid; and
a temperature management system according to claim 1.
